(19) United States
(12) Patent Application Publication
(10) Pub. No.: US 2025/0002305 A1
(43) Pub. Date: Jan. 2, 2025

(54) WIND TURBINE TOWER INSTALLATION APPARATUS AND METHOD

(71) Applicant: Nekkar ASA, Kristiansand S (NO)

(72) Inventors: Yngvar Borø, Søgne (NO); Ricardo Nuno Correia, Flekkerøy (NO); Adrian Mihai Orasanu, Flekkerøy (NO); Arild Andersen, Kristiansand (NO)

(73) Assignee: Nekkar ASA, Kristiansand S (NO)

(21) Appl. No.: 18/576,895

(22) PCT Filed: Jun. 22, 2022
(86) PCT No.: PCT/NO2022/050147

§ 371 Date: Jan. 5, 2024

(30) Foreign Application Priority Data
Jul. 7, 2021 (NO) 20210882

(51) Int. Cl. B66C 23/20; F03D 13/10

(52) U.S. Cl. CPC B66C 23/207; F03D 13/10; F05B 2230/61

(57) ABSTRACT

A wind turbine tower installation apparatus and methods of erecting a wind turbine tower. The wind turbine tower installation apparatus is arranged for installing a tower having a plurality of longitudinally stackable sections. The apparatus has a frame having a guide for positioning the apparatus on an installed tower portion, a platform for supporting wind turbine components on the frame, and a mechanism for transversely positioning the supported wind turbine component in alignment with the tower. The apparatus also has a lifting mechanism for moving the apparatus longitudinally up and down the installed tower portion. A motion detector is provided for detecting movement of the installed tower portion and a motion control system configured to apply counter-load inputs from the installation apparatus to the installed tower portion.

### CROSS-REFERENCE TO RELATED APPLICATIONS

This application is the U.S. national stage application of International Application No. PCT/NO2022/050147, filed Jun. 22, 2022, which international application was published on Jan. 13, 2023 as WO 2023/282758 in the English language. The International Application claims priority to Norwegian patent application Ser. No. 20/210,882, filed Jul. 7, 2021. The international application and Norwegian application are both incorporated herein by reference, in their entirety.

### FIELD

The present invention relates to a wind turbine tower installation apparatus and methods of erecting a wind turbine tower.

### BACKGROUND

The invention relates to the technical field of wind turbines, and more specifically to the installation and construction of wind turbines.

For increased efficiency it is desirable to provide wind turbines with larger rotor areas (to increase the capacity of the turbine) and to position the turbine at a higher elevation (as wind speeds typically increase with altitude and wind is subject to less disruption). As such, there is a trend towards building wind turbines with towers having much greater length. Further, the growth of offshore wind turbines is an additional driving factor towards larger and taller wind turbines.

As wind turbines grow taller the installation process becomes more challenging such that there is a need for effective methods and apparatus for successful installation of tall wind turbines. Conventionally, the wind turbine tower is constructed of a series of longitudinally stackable tubular sections which must be placed and secured end on end. The assembly process therefore comprises first installing a base section of the tower (for example embedded on a platform or foundation) before installing the tower sections in sequence followed by a nacelle and blades on the final section. This installation is carried out using extremely large cranes, but the size of the cranes is such that significant work and infrastructure is required to merely position and install the cranes before work can commence on the wind turbine itself. For example delivery of the parts of a crane to an installation site may require some 80 semi-trailers. Furthermore, it may be very challenging, and require acceptable weather conditions, to install parts of the wind turbine, particularly the uppermost parts, when they are lifted by a crane separate from the tower, for example because of relative movement of the crane and the tower.

Accordingly, the applicant has proposed (in their co-pending Norwegian patent applications No20201367, NO20201368, NO20201369 all having a filing date of 11 Dec. 2020) an apparatus and method for performing parts of an operation to install a tower for a wind turbine in which an apparatus comprising a travelling car for travelling up and down along an installed tower section of the wind turbine and for carrying an item to be installed as part of the wind turbine. This apparatus and method provides significant potential advantages over the conventional, crane based, methods of installation. Embodiments of the invention seek to provide further improvements and/or alternatives to the apparatus and method.

### SUMMARY

According to a first aspect of the invention, there is provided a wind turbine tower installation apparatus for installing a tower comprising a plurality of longitudinally stackable sections, wherein the apparatus comprises: a frame comprising a guide for positioning the apparatus on an installed tower portion, a platform for supporting wind turbine components on the frame, and a mechanism for transversely positioning the supported wind turbine component in alignment with the tower; and a lifting mechanism for moving the apparatus longitudinally up and down the installed tower portion, the apparatus being characterised by further comprising: a motion detector for detecting movement of the installed tower portion; and a motion control system configured to apply counter-load inputs from the installation apparatus to the installed tower portion. The counter-load inputs may for example be counter-oscillations.

Embodiments of the invention may be particularly useful in preventing or managing oscillations of the tower during installation. For example vortex shedding of wind passing across the assembled portion of the tower which may cause vortex induced oscillations. In particular embodiments may help to ensure that the partially assembled tower portion is not subject to harmonic oscillations which can be potentially damaging. As such, embodiments of the invention may provide advantages in removing the need for additional damping measures during manufacturing such as the use of sandbags or tower spirals. Embodiments may also avoid the need for the use of a dedicated anti-sway unit during tower assembly which would add further installation time and equipment cost. Further, embodiments may provide better and safer operating conditions during installation which may for example enable the weather window for safe operating conditions to be expanded.

The motion control system may be configured to counter oscillation of the installed tower portion. As such the motion control system may selectively apply counter-load inputs at a plurality of circumferentially distributed locations to counter oscillations of the tower.

In embodiments the guide of the frame may comprise an aperture for circumferentially surrounding the external wall of a local portion of the installed tower and a plurality of guide members projecting into the aperture to engage the external wall. The guide members may be radially adjustable to align the frame relative to the installed tower. The guide members may slidingly abut the outer surface of the external wall of the installed tower when the installation apparatus is moving longitudinally up and down the installed tower portion. The primary purpose of the guide may be to transversely align the frame of the apparatus relative to the tower, for example providing a self-centring mechanism for the frame.

The guide members may extend from a proximal end at the frame to a distal end (adjacent to the tower in use). The distal end may comprise a roller or wheel to engage the external wall. The plurality of guide members may be circumferentially distributed around the aperture. The guide members may be arranged in radially opposed sets, for example the opposing guide members of each radially opposed sets may act in use as an antagonistic pair acting between the frame of the apparatus and the tower.

The motion control system may utilise the guide members to provide counter-loads inputs, for example the motion control system may adjusts the position of the guide members to provide counter-loads inputs.

Additionally or alternatively, the counter-load inputs may comprise at least one moveable weight attached to the frame. The motion control system may use movement of the weight to provide counter-loads inputs. For example, the (or each) moveable weight may be mounted to the frame via an actuator. The motion control system may use the actuator to move the moveable weight to generate counter forces (such as counter-oscillations). A plurality of moveable weights may be provided and may be distributed about the frame. For example, at least one pair of moveable weights may be provided on opposing sides of the guide of the frame.

The lifting mechanism may comprise at least one winch and a plurality of lifting ropes circumferentially distributed around the tower. In some embodiments a winch may for example be provided for each lifting rope. Each lifting rope may be attached, in use, proximal to the free end of the installed tower portion. In some embodiments the motion control system may be configured to apply counter-load inputs by adjusting the tension in the plurality of lifting ropes. The motion control system may use the tension in the lifting ropes in conjunction with or as an alternative to adjustment of the guide members. In particular, the adjustment of the tension in the lifting ropes may provide an effective counter-load approach when the installation apparatus is in a fixed position, for example when the apparatus is parked on its landing platform. The motion control system may use the tension adjustment to maintain a symmetric loading on the tower.

The motion detector may include at least one motion reference unit (MRU) connected to the frame of the apparatus. Alternatively or additionally the motion detector may include at least one motion reference unit connected to the installed tower section. The motion reference unit may provide an inertial measurement unit with single or multi-axis motion sensors (for example MEMS gyroscopes and/or accelerometers). The motion detector may also detect the position of the apparatus, for example the position relative to the tower. Detected position data may for example be used by the motion control system to determine the required counter-loading based upon detected motion. The motion detector may be further provided with wind data measurements. For example, the motion detector could be provided with direct or indirectly measured data on wind strength and direction. Other inputs to the motion detector could for example include load sensors on the installed tower section and/or the installation apparatus.

According to a further aspect of the invention there is provided a method of erecting a wind turbine tower, the method comprising the steps of: installing a tower section; attaching a moveable installation apparatus to the installed tower section for supporting and positioning subsequent tower sections; detecting movement of the installed tower section; and applying counter-load inputs to the installed tower section from the moveable installation apparatus to reduce or eliminate tower movement.

The step of applying counter-load inputs may comprise applying inputs to the tower using an alignment mechanism of the moveable installation apparatus to apply transverse loads to the tower. The step of applying counter-load inputs may additionally or alternatively comprise applying inputs to the tower by adjusting the tension of a lifting mechanism of the moveable installation apparatus.

The method may further comprise providing at least one motion reference unit (MRU) on the moveable installation apparatus. The method may comprise detecting movement of the installed tower section using said MRU.

Unless otherwise stated, each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Whilst the invention has been described above, it extends to any inventive combination of the features set out above or in the following description or drawings.

### BRIEF DESCRIPTION OF THE DRAWINGS

Embodiments of the invention may be performed in various ways, and embodiments thereof will now be described by way of example only, reference being made to the accompanying drawings, in which:

FIGS. 1 to 14 illustrate parts of an operation to install a wind turbine which may incorporate embodiments of the invention;

FIGS. 15 to 20 illustrate apparatus and methods in accordance with embodiments of the invention.

### DETAILED DESCRIPTION OF THE EMBODIMENTS

Note that the embodiments shown in the figures are mere examples of the invention, and that they are not necessarily drawn to scale. Other embodiments being configured differently from those shown in the figures may be within the scope of the invention according to the claims.

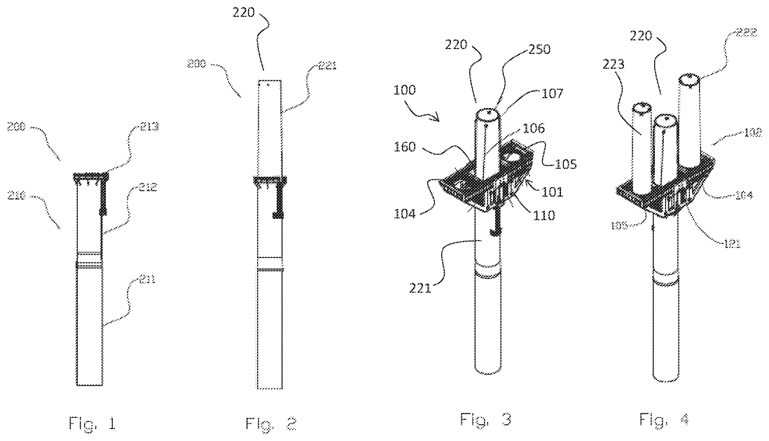

As noted above, the applicant has proposed an apparatus and method for performing parts of an operation to install a tower for a wind turbine. This apparatus and method will be briefly described with reference to FIGS. 1 to 14. These illustrations show a wind turbine at different points in time during installation. It will be appreciated that the steps shown are not considered limiting on the present invention but are provided for reference.

FIG. 1 shows an example of a base 210 for a wind turbine 200. The base 210 typically comprises a foundation piece 211 and a transition piece 212. The transition piece 212 includes a base working platform 213. Methods in accordance with embodiments of the invention may include the step of providing the base 210 or, alternatively, the base 210 may be of another type, e.g. any other type of base known from the prior art. For example, the provision of a foundation 211 and transition 212 pieces may be typically in an offshore foundation but may not be required in other installations. The first tower section in a land-based installation may, for example, be directly bolted to a concrete foundation. It will thus, be appreciated that embodiments are applicable to both land and offshore applications. FIG. 2 shows the same wind turbine 200, with the addition of a first, base, section 221 of the tower 220 of the wind turbine 200. It may be appreciated the tower 220 of the wind turbine 200 comprises a plurality of such sections which are longitudinally stackable to form the full length of the tower 220. The base section 221 may typically, but not necessarily, be installed atop the transition piece 212 by use of a crane device (not shown).

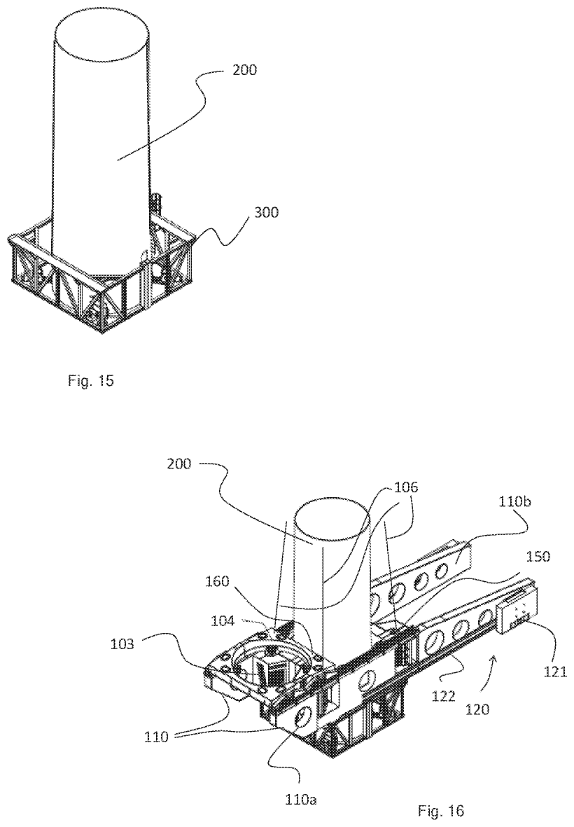

As shown in FIG. 3, once a first tower section 221 has been installed, an installation apparatus 100 in accordance with embodiments may be connected to the tower 220. The apparatus 100 will be described in further detail below but generally comprises a movable portion, referred to herein as a “travelling car” 101, which travels up and down along the longitudinal axis of the tower. The travelling car 101 is carried on load bearing lifting ropes 106 which are attached to a set of lifting lugs 107 provided at, or proximal, to the free end 250 of the installed section 221 of the tower 220. One or more winches 103 (see FIG. 16) are provided on the travelling car 101 to act upon the lifting ropes 106. Prior to the installation of the travelling car 101, a landing frame 300 (as shown in FIG. 15) or resting flange may be installed on the tower 220 or base 210 to provide a fixed base for the travelling car.

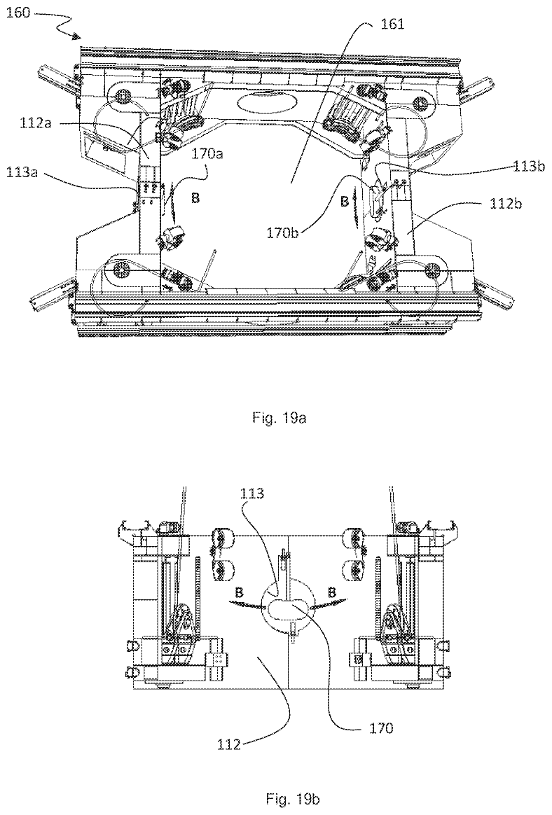

The travelling car 101 comprises a frame 110 defining a generally horizontal platform 102 (see FIG. 4) which extends transversely beyond the tower 220. A central portion of the frame 110 surrounds the installed tower section 221 and provides a guide 160 for positioning the apparatus 100. The guide 160 may, for example, include wheels or rollers (see FIG. 18 below) which engage and move along the outer surface of the tower section 221. The apparatus 100 further includes a mechanism for transversely positioning supported wind turbine components in alignment with the tower (i.e. for moving the component or components laterally along the platform 102). In the embodiment of FIGS. 1 to 14, two such transverse positioners 104, 105 are provided. Each of the first and the second transverse positioner 104, 105 are configured for carrying an item to be installed as part of the wind turbine 200. The travelling car 101 may further include a counter-balance device 120 (best seen in FIG. 16) for balancing the travelling car 101. The counter-balance device may include at least one weight 121 moveably mounted on a track 122 associated with the frame 110 such that the weight may be moved transversely to counter the weight of components carried on the travelling car 101.

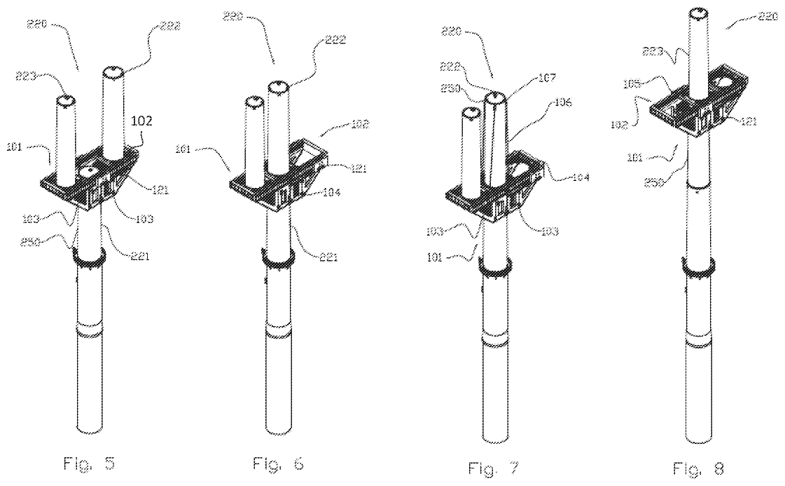

In FIG. 4, a first and a second subsequent sections 222, 223 for the tower 220 have been secured respectively on the first and the second transverse positioners 104, 105 of the platform 102 (with the transverse positioners in their initial positions). A crane may for example be used to load the sections onto the apparatus 100. As shown in FIG. 5, the travelling car 101, carrying the first and the second sections 222, 223, moves to an elevated position. In this elevated position, the deck 102 is slightly above the uppermost installed section of the tower 250.

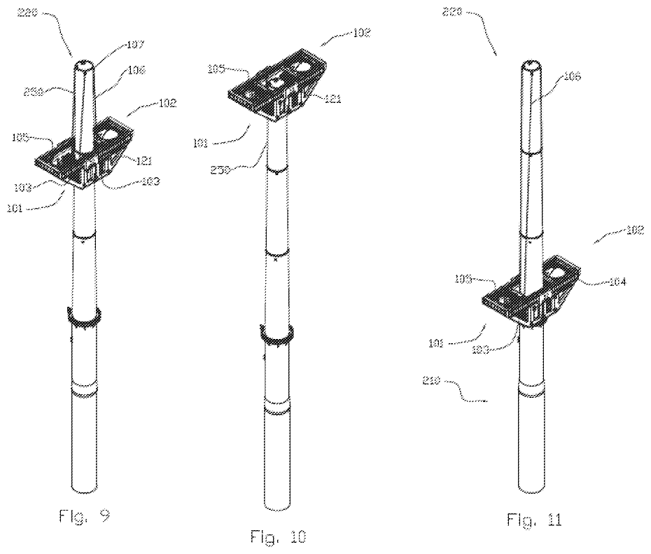

Subsequently, in FIG. 6, the first transverse positioner 104 of the deck 102 has moved to a central position of the travelling car 101 to transversely position its supported wind turbine component directly above the uppermost installed section (base section 221) of the tower 220. To balance the travelling car 101 after/while moving the first section 222 to the central position, the weight 121 of the counter-balancing device has been moved to the side of the travelling car 101 where the first section 222 was held prior to it being moved centrally. Moving the weight 121 in the opposite direction of the first section 222, offsets an imbalance that would otherwise have been caused by the movement of the first section 222. The tower section 221 and 222 may then be secured together (as will be described in further detail below).

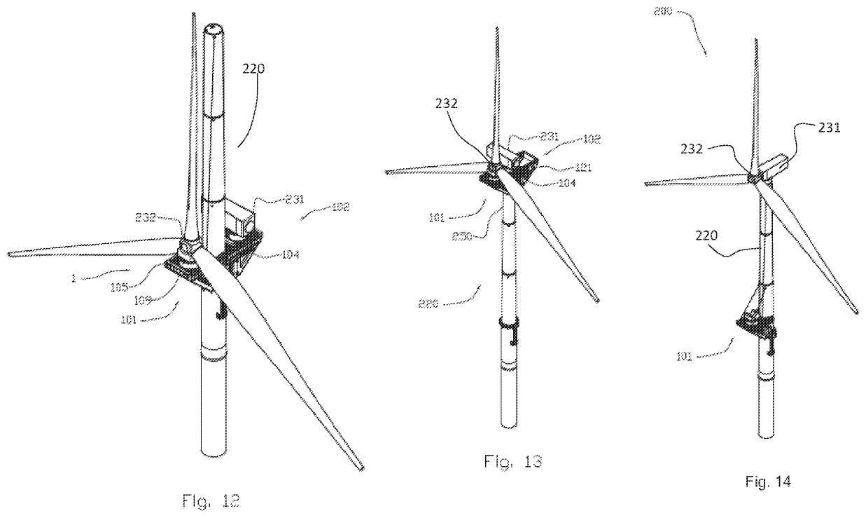

As can be further seen in FIG. 7, after installing the section 222 the lifting lugs 107 and the ropes 106 of the lifting mechanism are moved to the upper end 250 of the installed portion. Thus, the winches 103 of the lifting mechanism may be used to move the travelling car 101 longitudinally along the next section. This enables the positioning and connection of the next section 223 to be installed in substantially the same manner as section 222 and as shown in FIG. 8.

Once the final tower section is installed (in this case 223) the lifting mechanism is again attached to the upper end of the installed tower section, as shown in FIG. 9. The travelling car 101 is then able to move longitudinally along the tower 220 between the upper end (the position shown in FIG. 10) and its landing frame, which, as shown in FIG. 11, may be at the connection between the tower 220 and base 210.

As shown in FIGS. 12 to 14, with the tower fully erected the installation apparatus 100 may be used to install subsequent wind turbine components. For example, the apparatus may be used for the installation of a nacelle 231 and a rotor 232. As shown in FIG. 12 the nacelle 231 and rotor 232 may be mounted on the travelling car 101 for lifting longitudinally along the tower 220. In FIG. 13, the travelling car 101 has been moved to the top of the tower 220 and the transverse positioners 104, 105 may be used to position the nacelle 231 and rotor 232. When the propeller with rotor blades 232 has been installed, the wind turbine 200 may be fully installed, or the part of the installation of the wind turbine 200 that involves use of the apparatus 100 may be completed as shown in FIG. 14.

The installation apparatus 100 is shown in further detail in FIGS. 15 and 16. FIG. 15 shows the landing frame 300 for the travelling car 101. The landing frame 300 may typically be configured for supporting the travelling car 101 when the travelling car is sitting at the base 210 of the wind turbine 200, for example when installing the travelling car 101 onto the tower or when the apparatus 100 is not in use.

FIG. 16 shows a detailed embodiment of the travelling car 101. The travelling car comprises a frame 110 which is formed from two side support trusses 110a and 110b which extend transversely along opposing sides of the tower. The frame 110 is constructed in two interconnectable halves which can be joined around the tower in use. The upper plane of the frame 110 defines the platform onto which is mounted at least one transverse positioning mechanism 104. It may also be noted that external sides of the frame 110 mounts the counter-balance system 120 with a weight 121 on rails 122. The frame may also support a power source 150, which may for example include a generator and/or battery. The power source 150 may supply power to any control systems and to the winches 103 the lifting mechanism.

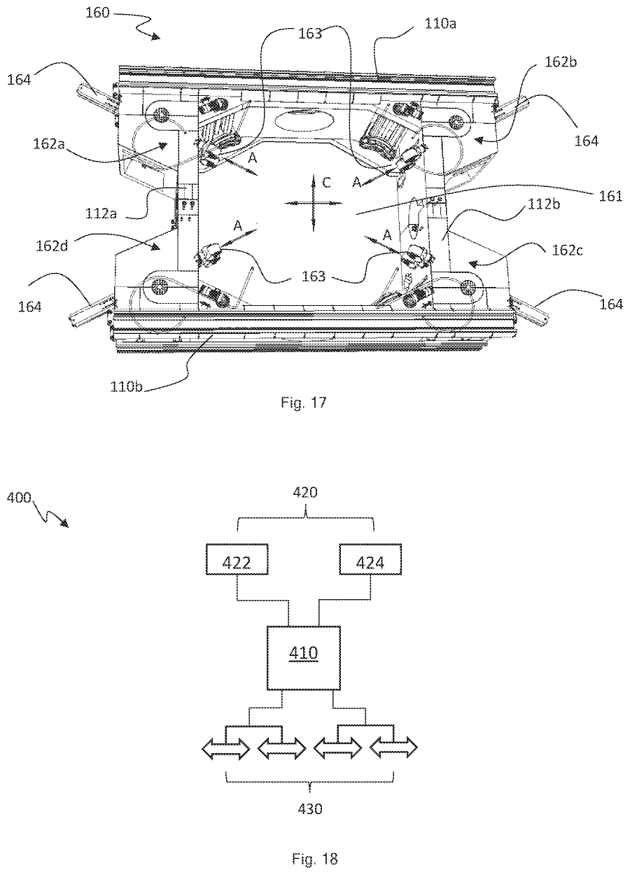

FIG. 17 shows the guide portion 160 of the frame 110 of the travelling car 101 in further detail. The guide portion 160 defines an aperture 161 which circumferentially surrounds the tower section on which the travelling car 101 is installed. The aperture 161 is defined by opposed portions of the side support trusses 110a and 110b and by two opposed cross members 112a and 112b that bridge between the trusses 110a and 110b. The guide 160 includes a set of four guide roller assemblies 162a, 162b, 162c and 162d each positioned proximal to a corner of the quadrilateral formed by the frame 110. Each guide roller assembly 162 comprises a pair of wheels 163 arranged in tandem configuration (along the axial direction of the tower). The wheels 163 are mounted at the end of support arms 164 which are generally radially projecting with respect to the axis of the tower such that the assemblies 162 project radially inwardly into the aperture 161. The support arms 164 include (or are connected to) an actuator such that the roller assemblies 162 can displace radially inwardly or outwardly (in the direction of arrows A) relative to the frame 110. Thus the wheels 163 may be positioned to abut and engage an outer surface of the tower 220. The primary function of the guide roller assemblies 162 may be to position and align the frame 110 (and therefore the travelling car 101) relative to the tower 220.

In accordance with embodiments of the invention, the guide rollers may also be used in a motion control system 400 during tower assembly (which is illustrated schematically in FIG. 18). The motion control system 400 detects movement of the installed section(s) of the tower 220 using a motion detector 420. In the example, the motion detector 420 includes both a motion detector 422 fixed relative to the frame 110 and a second motion detector 424 fixed relative to the installed portion of the tower 220 (although it will be appreciated that either of these motion detectors may be omitted). The (or each) motion detector may be a motion reference unit providing an inertial measurement unit with single or multi-axis motion sensors (for example MEMS gyroscopes and/or accelerometers). The data from the motion detectors 420 is received by a controller 410 (which may be a dedicated controller or integrated into a general control system). The controller 410 uses the motion data to determine counter-loading requirements and issue commands to actuators 430 of the motion control system which will prevent or dampen the movement of the tower 220. In particular, the controller 410 may be arranged to ensure that the motion of the tower 220 does not approach potentially dangerous harmonic oscillations (for example, whilst the fully assembled tower may be optimised to avoid such oscillations occurring in normal weather conditions, it may be more difficult to avoid such occurrences during assembly of the tower). The controller 410 may include additional inputs or calculations to ensure the reliability of the issued control commands, for example the controller may determine the relative position and movement of the travelling car 101 so as to ensure that both measured movements and counter-loads are optimised. In some embodiments the controller may also receive additional data such as wind strength and direction (for example from a gauge mounted to the frame 110) or direct load measurements from the tower 220 and/or frame 110.

When operating the guide roller assemblies 162 as counter-load actuators opposed guide roller assemblies (162a and 162c, 162b and 162d) are actuated in a complimentary push-pull manner (as antagonistic pair). By moving the guide assemblies 162 in a coordinated way the adjustment of the centre point C of the guide 160 can be provided and will result in counter-loads being transferred to the tower. The control system 300 operates the actuators of the guide roller assemblies 162 to counter-load against detected movements and can therefore reduce or eliminate the effects of tower movement during use. It will be appreciated that this action may be used to both stabilise/isolate the travelling car (for example to improve working conditions) and to reduce movement of the installed portion of the tower so as to dampen oscillations caused for example by wind.

An alternate actuation arrangement for the counter-load input is shown in FIGS. 19a and 19b. In this embodiment the actuators of the motion control system 300 are used to input counter-acting movements using a pair of moveable weights 170. The guide wheel assemblies 162 of this embodiment are substantially the same as the previous embodiment but are not required to be used as part of the motion control system 300 (for example they may still be radially adjustable to enable alignment of the frame and tower). The moveable weights are moveably mounted to the frame 110 proximal to the aperture 161 of the guide 160. As seen in FIG. 19a the moveable weights 170a 170b are arranged as an opposing pair each located within an aperture 113a and 113b in the opposed cross members 112a and 112b. The moveable weights 170 are arranged in a pendulum arrangement such that they can be swung by the actuator as shown by arrows B (it will however be appreciated that other arrangements such as linear or rotary actuation may also be suitable for generating counter-loads using moveable weights). In use, the controller 310 of the motion control system 300 uses the inputs from the motion detector 320 and determines the required movement of the weights 170 before sending commands to the actuators 330 of the weights. In some embodiments the moveable weights 170 may be movable in both the X and Y directions to provide counter-loads in both axis. In other embodiments the moveable weights may provide counter-loads in one axis and the controller 310 may make adjustments to the position of the weights 121 of the counter-balance 120 to provide counter-loads in the other axis.

As noted above with respect to FIGS. 15 and 16, the assembly apparatus may include a landing frame 300 and when not being actively used the travelling car 101 may be docked to the landing frame 300. In such a configuration, the motion control system based upon counter loads from the guide roller assemblies or movable weights may be ineffective in damping tower movement. As such embodiments may further use the motion control system to apply counter loads to the tower using the lifting ropes 106. By commanding the winches 103 to apply tension to the ropes 106 with the travelling car 101 in a fixed position the motion control system 300 can apply stabilising loads to the tower 220. The control system 300 can adjust the tension in the ropes individually or collectively to change the load for example when movement of the tower has been detected. The control system 300 adjust the winches 103 to achieve a symmetric load distribution on the tower. When it is necessary to move the mounting point of the ropes 106 to the free end of the next installed tower section (i.e. moving the lifting lugs 107 or connecting the rope 106 to new lifting lugs) stabilising tension from the motion control system can be maintained by the control system 300 in the attached ropes whilst each rope is moved to the next position.

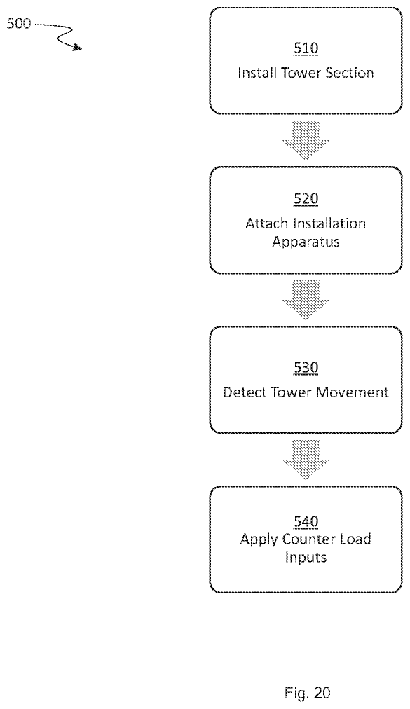

The method according to embodiments of the invention is shown schematically in FIG. 20. The method 500 includes the initial step 510 of installing a tower section followed by the step 520 of attaching an installation apparatus to the tower section. These steps may be generally as described above with reference to FIGS. 1 to 14. The method further comprises the step 530 of detecting tower movement, for example by using sensors connected to a control system as described with reference to FIG. 18. The method then comprises the step 540 of applying a counter-load inputs, for example counter oscillations, to remove or alleviate the detected movement.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

Although the invention has been described above with reference to preferred embodiments, it will be appreciated that various changes or modification may be made without departing from the scope of the invention as defined in the appended claims.

1. A wind turbine tower installation apparatus for installing a tower comprising a plurality of longitudinally stackable sections, wherein the apparatus comprises:
a frame comprising
a guide for positioning the apparatus on an installed tower portion,
a platform for supporting wind turbine components on the frame, and
a mechanism (104) for transversely positioning the supported wind turbine component in alignment with the tower; and
a lifting mechanism for moving the apparatus longitudinally up and down the installed tower portion,
a motion detector for detecting movement of the installed tower portion, and
a motion control system configured to apply counter-load inputs from the installation apparatus to the installed tower portion.

2. The wind turbine tower installation apparatus as claimed in claim 1, wherein the motion control system selectively applies counter-load inputs at a plurality of circumferentially distributed locations to counter oscillations of the tower.

3. The wind turbine tower installation apparatus as claimed in claim 1, wherein the guide of the frame comprises an aperture for circumferentially surrounding the external wall of a local portion of the installed tower and a plurality of guide members projecting into the aperture to engage the external wall, the guide members being radially adjustable to align the frame relative to the installed tower.

4. The wind turbine tower installation apparatus as claimed in claim 3, wherein the guide members extend from a proximal end at the frame to a distal end and the distal end comprises a roller or wheel to engage the external wall.

5. The wind turbine tower installation apparatus as claimed in claim 3, wherein the plurality of guide members are arranged as a plurality of radially opposed sets of guide members circumferentially distributed around the aperture.

6. The wind turbine tower installation apparatus as claimed in claim 3, wherein the motion control system adjusts the position of the guide members to provide counter-loads inputs.

7. The wind turbine tower installation apparatus as claimed in claim 1, wherein the motion control system further comprises at least one moveable weight attached to the frame and wherein the motion control system moves the weight to provide counter-loads inputs.

8. The wind turbine tower installation apparatus as claimed in claim 1, wherein the lifting mechanism comprises at least one winch and a plurality of lifting ropes circumferentially distributed around the tower, each lifting rope being attached proximal to the free end of the installed tower portion.

9. The wind turbine tower installation apparatus as claimed in claim 8, wherein the motion control system is configured to apply counter-load inputs by adjusting the tension in the plurality of lifting ropes with the frame of the apparatus fixed in position relative to the installed tower.

10. The wind turbine tower installation apparatus as claimed in claim 1, wherein the motion detector includes at least one motion reference unit connected to the frame of the apparatus.

11. The wind turbine tower installation apparatus as claimed in claim 10, wherein the motion detector is further configured to detect the position of the apparatus.

12. A method of erecting a wind turbine tower, the method comprising the steps of:
installing a tower section;
attaching a moveable installation apparatus to the installed tower section for supporting and positioning subsequent tower sections;
detecting movement of the installed tower section; and
applying counter-load inputs to the installed tower section from the moveable installation apparatus to reduce or eliminate tower movement.

13. The method of claim 12, wherein the step of applying counter-load inputs comprises applying inputs to the tower using an alignment mechanism of the moveable installation apparatus to apply transverse loads to the tower.

14. The method of claim 12, wherein the step of applying counter-load inputs comprises applying inputs to the tower by adjusting the tension of a lifting mechanism of the moveable installation apparatus.

15. The method of claim 12, further comprising providing at least one motion reference unit on the moveable installation apparatus and detecting movement of the installed tower section using said motion reference unit.

16. The wind turbine tower installation apparatus as claimed in claim 2, wherein the guide of the frame comprises an aperture for circumferentially surrounding the external wall of a local portion of the installed tower and a plurality of guide members projecting into the aperture to engage the external wall, the guide members being radially adjustable to align the frame relative to the installed tower.

17. The wind turbine tower installation apparatus as claimed in claim 4, wherein the plurality of guide members are arranged as a plurality of radially opposed sets of guide members circumferentially distributed around the aperture.

18. The wind turbine tower installation apparatus as claimed in claim 4, wherein the motion control system adjusts the position of the guide members to provide counter-loads inputs.

19. The wind turbine tower installation apparatus as claimed in claim 5, wherein the motion control system adjusts the position of the guide members to provide counter-loads inputs.
